(19) United States
(12) Patent Application Publication
(10) Pub. No.: US 2024/0302837 A1
(43) Pub. Date: Sep. 12, 2024

(54) SYSTEMS, APPARATUS, AND METHODS TO IMPROVE PERFORMANCE EFFICIENCY OF AUTONOMOUS ROBOTS

(71) Applicant: 6 River Systems, LLC, Waltham, MA (US)

(72) Inventors: Akshay Vishwakarma, Brampton (CA); Ellen Patridge, Somerville, MA (US); Catherine Jones, Waltham, MA (US)

(21) Appl. No.: 18/179,033

(22) Filed: Mar. 6, 2023

(51) Int. Cl. G05D 1/00

(52) U.S. Cl. CPC G05D 1/0027

(57) ABSTRACT

Systems, apparatus, and methods to improve performance efficiency of autonomous robots are disclosed. An example apparatus includes processor circuitry to identify a first and a second task; detect a first condition associated with a first location, the first condition to affect a first task performance condition associated with performance of the first task by an autonomous vehicle, the first condition including congestion at the first location; detect a second condition associated with a second location, the second condition to affect a second task performance condition associated with performance of the second task by the autonomous vehicle; select one of the first or the second task to be performed based on the first and the second condition; and cause the autonomous vehicle to travel to the first or the second location to perform the selected one of the first or the second task.

### FIELD OF THE DISCLOSURE

This disclosure relates generally to autonomous robots and, more particularly, to systems, apparatus, and methods to improve performance efficiency of autonomous robots.

### BACKGROUND

An autonomous robot can be used in a warehouse to perform tasks such as retrieving and carrying goods. More than one autonomous robot may be traveling in the warehouse at a given time and, in some instances, in proximity to one another in the warehouse. For instance, two or more autonomous robots may be traveling down one aisle of the warehouse at the same time. Also, individual workers and/or other types of equipment, such as manually operated forklifts, may be moving within the warehouse during travel of the autonomous robots.

### BRIEF DESCRIPTION OF THE DRAWINGS

FIG. 1 illustrates an example system in accordance with teachings of this disclosure including autonomous robots in an environment and example workload control circuitry for assigning tasks to the autonomous robots in accordance with teachings of this disclosure.

FIG. 2 is a block diagram of an example autonomous robot of FIG. 1.

FIG. 3 is a block diagram of example machine learning model training circuitry.

FIG. 4 is a block diagram of the example workload control circuitry.

FIG. 5 is a flowchart representative of example machine readable instructions and/or example operations that may be executed by example processor circuitry to implement the machine learning training control circuitry of FIG. 3.

FIG. 6 is a flowchart representative of example machine readable instructions and/or example operations that may be executed by example processor circuitry to implement the workload control circuitry of FIG. 4.

FIG. 7 is a block diagram of an example processing platform including processor circuitry structured to execute the example machine readable instructions and/or the example operations of FIG. 5 to implement the machine learning model training circuitry of FIG. 3.

FIG. 8 is a block diagram of an example processing platform including processor circuitry structured to execute the example machine readable instructions and/or the example operations of FIG. 6 to implement the workload control circuitry of FIG. 4.

FIG. 9 is a block diagram of an example implementation of the processor circuitry of FIGS. 7 and/or 8.

FIG. 10 is a block diagram of another example implementation of the processor circuitry of FIGS. 7 and/or 8.

FIG. 11 is a block diagram of an example software distribution platform (e.g., one or more servers) to distribute software (e.g., software corresponding to the example machine readable instructions of FIG. 8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

Unless specifically stated otherwise, descriptors such as “first,”“second,”“third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

As noted above, an autonomous robot can be used in a warehouse to perform tasks such as retrieving and carrying goods. More than one autonomous robot may be traveling in the warehouse at a given time and, in some instances, in proximity to one another in the warehouse. For instance, two or more autonomous robots may be traveling down one aisle of the warehouse at the same time as each robot performs an assigned task. Also, individual workers and/or other types of equipment, such as manually operated forklifts, may be moving within the warehouse during travel of the autonomous robots and, in particular, within travel paths of the robots.

In some examples, an autonomous robot is assigned a pending or uncompleted task by a central source such as a dispatcher or a warehouse management system using an algorithm that assigns tasks based on a current availability of the robot. The tasks can be assigned based on variables such as which task is next to be completed in a chronological order of uncompleted tasks, which task has highest priority relative to other uncompleted tasks, etc. However, assignment of tasks based on chronological order or priority alone does not account for conditions in the warehouse that can affect completion of the tasks.

For instance, the highest priority task may involve good(s) located in an area where other robots and/or equipment are located at a particular time. In some known examples, a robot may be assigned the highest priority task without consideration for the presence of other robots or equipment proximate to the location of the good(s) to be retrieved in connection with execution of the highest priority task. As a result, the robot will travel into an area of congestion.

Autonomous robots include safety features to prevent or mitigate accidents between other autonomous robots, equipment, and/or individuals. For example, if the autonomous robot detects an obstacle within a travel path of the autonomous robot, the autonomous robot may take one or more actions to prevent a collision, such as a stopping and refraining from traveling until the obstacle has cleared, revising the travel path, reducing speed, etc.

When assigned a task to, for instance, retrieve a good from a location in a warehouse, a first autonomous robot navigates to the location. However, congestion within the warehouse can affect the efficiency of the first autonomous robot in performing the task. For instance, the first autonomous robot may detect the presence of a first obstacle in an aisle through which the first autonomous robot is traveling, such as a manually operated forklift. The first autonomous robot may stop for a period of time until the first obstacle clears. Upon resuming travel, the first autonomous robot may detect a second obstacle in the aisle, such as a second autonomous robot retrieving a good proximate to the destination of the first robot. As such, the first autonomous robot may stop traveling again until the second autonomous robot has moved. The frequent stopping of the first autonomous robot decreases the efficiency of the first autonomous robot in performing the task by reducing a speed at which the first autonomous vehicle performs the task. The disruptions also interfere with operation of the first robot (e.g., the first autonomous robot may need to be instructed or reset to resume travel). Thus, congestion in the warehouse can result in unnecessary consumption of autonomous robot resources (e.g., power consumption, wear) as well as processing resources to control the robot and, in general, affect efficiency of the operation of the robot.

Disclosed herein are example systems, apparatus, and methods that provide for scheduling of tasks to be performed by autonomous robots (e.g., autonomous vehicles) by considering performance efficiency of the autonomous robots in completing the tasks. In examples disclosed herein, performance efficiency can include efficiency at which the autonomous robots navigate an environment such as a warehouse to perform a task (e.g., minimization of travel disruptions, reduction in unplanned stops) and/or efficiency in execution of the task (e.g., based on robot type).

Examples disclosed herein selectively assign pending or uncompleted task(s) to an autonomous robot to increase efficiency of the robot in performing the task(s) in view of properties of the task(s) (e.g., characteristics of the goods associated with the task, completion deadline) as well as conditions in the environment (e.g., a warehouse) in which the robot is located that can affect performance of the task(s) by the robot. Some examples disclosed herein schedule performance of task(s) by an autonomous robot to minimize congestion in the warehouse due to the presence of other autonomous robots, individual workers, and/or other types of equipment (e.g., manually operated equipment) in the warehouse.

For instance, when a robot is available to perform a task, examples disclosed herein may not assign the highest priority task or oldest task to the robot if the robot would not be able to complete such a task as efficiently as another pending task. For instance, if the highest priority uncompleted task would cause the robot to travel to a congested area in the warehouse to complete the task, thereby slowing down completion of the task, examples disclosed herein may instead select another pending task for the robot to complete that causes the robot to travel to a less congested area of the warehouse. Examples disclosed herein can subsequently evaluate which available robot should receive the highest priority task based on, for instance, changes in congestion levels over time, robot type, etc.

Examples disclosed herein provide for optimization of performance efficiency of autonomous robots when assigning tasks to the robots. Examples disclosed herein consider both local variables when assigning a task to an autonomous robot as well as global variables related to activity in the warehouse. The local variables can include, for instance, characteristics of the order and/or good(s) of the order to be retrieved (e.g., size, weight, deadline for completion of the order, location in the warehouse) and/or characteristics of the autonomous robot (e.g., availability, capacity). The global variables can include current and/or expected locations of other autonomous robots, equipment, and/or individuals in the warehouse at a particular time; properties of other orders being fulfilled in the warehouse at a given time (e.g., whether an order may require additional time and/or equipment to retrieve from a shelf, whether multiple orders include goods stored at a similar location in the warehouse, order fulfillment time requirements, etc.), etc. The local and/or global variables can be identified from, for instance, order data; outputs of sensors associated with autonomous robots and/or other equipment in the warehouse; outputs of handheld devices carried by individual workers; historical task performance data; etc.

Some examples disclosed herein consider robot type and/or equipment type when assigning pending or uncompleted tasks. Some examples may account for differences in robots such as size, storage area capacity, etc. when assigning tasks. Some examples disclosed herein may choose to assign a task different than, for instance, a high priority task, to a particular robot if the robot could perform another task more efficiently based on the robot type (e.g., an autonomous robot having a forklift versus an autonomous robot having an arm to reach items on a shelf). Some examples disclosed herein consider other types of equipment (e.g., a manually operated forklift) when assigning tasks to robots.

Although examples disclosed herein are discussed in connection with a warehouse storing inventory, examples disclosed herein can be implemented in connection with other environments including autonomous robots. Thus, examples disclosed herein are not limited to inventory storage warehouses.

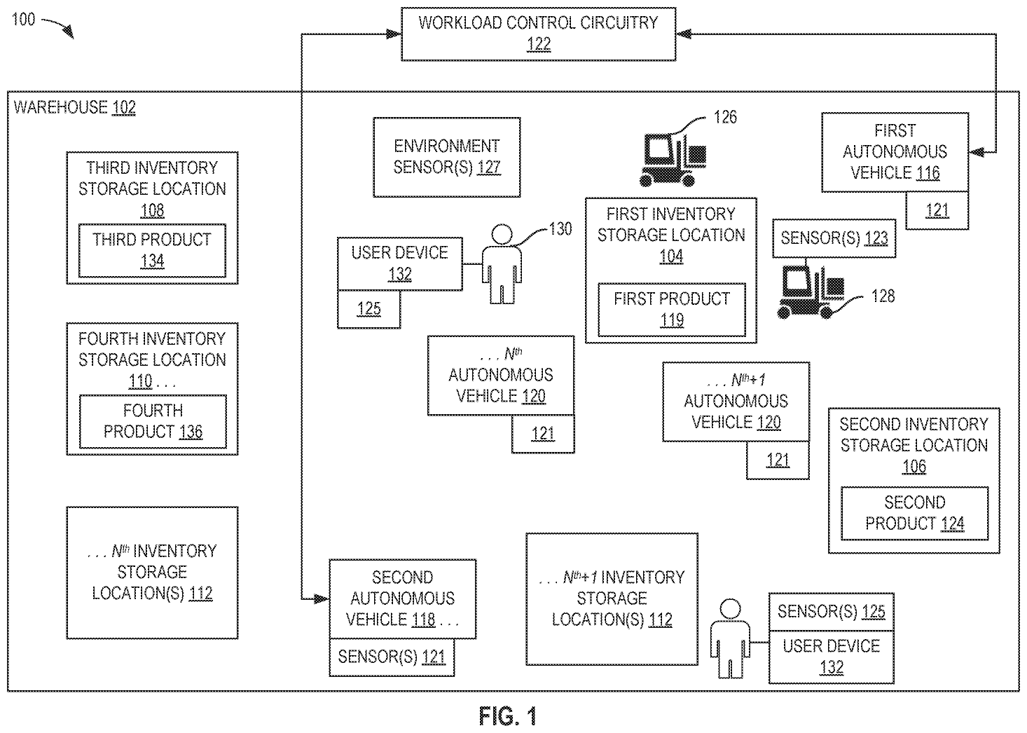

FIG. 1 illustrates an example system 100 in accordance with teachings of this disclosure. In the example of FIG. 1, a warehouse 102 stores inventory (e.g., product(s)) for one or more merchants (e.g., retailer(s), seller(s), or other provider(s)). The warehouse 102 includes storage locations for storing inventory, such as shelves, boxes, bins, baskets, and/or other means for storing inventory. For illustrative purposes, the warehouse 102 of FIG. 1 includes a first inventory storage location 104, a second inventory storage location 106, a third inventory storage location 108, a fourth inventory storage location 110, and n other inventory storage location(s) 112. Each of the storage locations 104, 106, 108, 110, 112 stores one or more products. In the example of FIG. 1, product(s) retrieved from the storage location(s) 104, 106, 108, 110, 112 associated with an order (e.g., an order received via a website of retailer or other seller) can be delivered to, for instance, an order assembly area where packaging of the order is performed.

In the example of FIG. 1, one or more autonomous robots are used to retrieve product(s) from the storage location(s) 104, 106, 108, 110, 112 to facilitate fulfillment of an order for the product(s). In the example of FIG. 1, the autonomous robots include autonomous vehicles (or automated vehicles). In particular, a first autonomous vehicle 116, a second autonomous vehicle 118, and n other autonomous vehicles 120 are located in the warehouse 102. The warehouse 102 can include additional or fewer autonomous vehicles than shown in FIG. 1. Also, the warehouse 102 can include other types of autonomous or automated robots.

In the example system 100 of FIG. 1, the autonomous vehicles 116, 118, 120 are communicatively coupled to workload control circuitry 122 (e.g., processor circuitry). The autonomous vehicles 116, 118, 120 travel in the warehouse 102 to particular inventory storage locations 104, 106, 108, 110, 112 in response to instructions received from workload control circuitry 122. For example, the workload control circuitry 122 can assign a task or workload to the first autonomous vehicle 116 in connection with a first order to cause the first autonomous vehicle 116 to move to the first inventory storage location 104 to retrieve a first product 119 stored at the first inventory storage location 104. The workload control circuitry 122 can cause the first autonomous vehicle 116 to leave the first inventory storage location 104 when the first product 119 has been loaded from the first inventory storage location 104 onto the first autonomous vehicle 116. In some examples, a user (e.g., a warehouse employee) loads the first product 119 onto the first autonomous vehicle 116. In some examples, the first autonomous vehicle 116 includes, for instance, a robotic arm to pick the first product 119 from the first inventory storage location 104 and move the first product 119 into a storage area of the first autonomous vehicle 116.

The workload control circuitry 122 manages assignment of tasks to the autonomous vehicles 116, 118, 120. For example, the workload control circuitry 122 receives orders placed by consumers via one or more order sources (e.g., an online store, a phone order). The workload control circuitry 122 identifies task(s) to be performed to facilitate completion of the order(s), such as retrieval of good(s) in the order(s) from the corresponding inventory storage locations 104, 106, 108, 110, 112. In some examples, one or more of the tasks to be performed (i.e., pending or uncompleted task(s)) may be assigned a higher priority level relative to other tasks due to, for instance, a deadline associated with an order. In some examples, the pending tasks are associated with a chronological order based on an age of the task. The tasks can be associated with the other properties such as a size, weight, location in the warehouse 102, etc.

In the example of FIG. 1, the workload control circuitry 122 identifies one or more autonomous vehicles 116, 118, 120 that are available or expected to be available to perform a given task. The workload control circuitry 122 can identify such autonomous vehicle(s) 116, 118, 120 based on, for example, (a) a status of tasks previously assigned to the autonomous vehicle 116, 118, 120 (or lack of assigned tasks) at a given time and (b) properties of the autonomous vehicle (e.g., size, capacity) in view of the properties of the tasks (e.g., size, weight, location) to be performed.

In assigning a task to a particular autonomous vehicle 116, 118, 120, the example workload control circuitry 122 also considers variables indicative of conditions in the warehouse 102 that may affect performance of the task. For example, the first autonomous vehicle 116 is available to perform a task. A first pending task can include retrieval of the first product 119 from the first inventory storage location 104. The first task can be associated with a higher priority level than a second pending task that includes retrieval of a second product 124 from the second inventory storage location 106. However, as illustrated in FIG. 1, an area of the warehouse 102 including the first inventory storage location 104 is congested in that two autonomous vehicles 120, a first manually operated equipment device 126 (e.g., a forklift), a second manually operated equipment device 128, and a first user 130 are proximate to the first inventory storage location 104.

The workload control circuitry 122 can identify conditions in the warehouse 102 such as congestion based on data output by, for instance, sensor(s) 121 carried by the autonomous vehicles 116, 118, 120; sensor(s) 123 carried by the equipment devices 126, 128; and/or sensor(s) 125 of a user device 132 carried by the user 130. The robot, equipment and/or user device sensors 121, 123, 125 can include, for example, position sensors to generate outputs indicative of location relative to the warehouse 102, image sensors to capture images of different areas of the warehouse 102 that can be analyzed by the workload control circuitry 122, etc. In some examples, the workload control circuitry 122 identifies conditions in the warehouse 102 based on one or more sensors 127 located in the warehouse 102. The environment sensor(s) 127 can include, for example, image sensors to capture images of the warehouse 102.

In view of the congestion, if the workload control circuitry 122 were to assign the first task to the first autonomous vehicle 116 to be performed prior to the second task, the congestion in the area of the first inventory storage location and/or along a vehicle travel path could decrease an efficiency at which the first autonomous vehicle 116 navigates to the first inventory storage location 104 and, thus, an efficiency at which the first autonomous vehicle 116 performs the first task. For instance, due to the congestion, the first autonomous vehicle 116 may stop travel to avoid collisions with the manually operated equipment devices 126, 128.

Instead, in this example, the workload control circuitry 122 instructs the first autonomous vehicle 116 to perform that second task to retrieve the second product 124 from the second inventory storage location 106. As illustrated in FIG. 1, the second inventory storage location 106 is located in a less congested area than the first inventory storage location 104. Thus, the first autonomous vehicle 116 can navigate to and perform the second task more efficiently than the first task. In some examples, the first autonomous vehicle 116 navigates to and performs the second task more efficiently than the first task even if the first autonomous vehicle 116 travels a further distance to the second inventory storage location 106 than the first inventory storage location 104 due to the lack of congestion at the second inventory storage location 106.

The workload control circuitry 122 can assign the first task to the first autonomous vehicle 116 after performance of the second task based on, for instance, monitoring of the congestion level at the first inventory storage location 104. In other examples, the workload control circuitry 122 instructs the second autonomous vehicle 118 to perform the first task while the first autonomous vehicle is performing the second task, at a later time, etc.

Although the foregoing example is discussed in connection with scheduling tasks in view of areas of congestion in the warehouse 102 to reduce or prevent navigational disruptions when performing tasks, the workload control circuitry 122 can consider other variables in assigning tasks. For example, the workload control circuitry 122 can consider differences in types of robots and the effects of robot type in performing different tasks. As an example, a third task can include retrieval of a third product 134 from the third inventory storage location 108 and a fourth task can include retrieval of a fourth product 136 from the fourth inventory storage location 110. In this example, the third task has been pending longer than the fourth task. Also, in this example, the third product 134 is located on a shelf at the third inventory storage location 108 while the fourth product 136 is resting on a ground surface at the fourth storage location 110.

The workload control circuitry 122 can identify that the first autonomous vehicle 116 is presently available to perform the third task. However, the workload control circuitry 122 identifies that the first autonomous vehicle 116 includes forks but does not include a robotic arm. In this example, to complete the third task using the first autonomous vehicle 116, a user would need a ladder to retrieve the third product 134 and place the third product 134 in the first autonomous vehicle 116.

The workload control circuitry 122 can determine that the second autonomous vehicle 118 will be available within a particular threshold of time and includes a robotic arm. Thus, the workload control circuitry 122 determines that the second autonomous vehicle 118 will be more efficient at completing the third task than the first autonomous vehicle 116. As such, the workload control circuitry 122 can instruct the first autonomous vehicle 116 to perform the fourth task, where the forks of the first autonomous vehicle 116 can provide for efficient completion of the fourth task to lift the fourth product 136 from the ground surface.

Thus, the workload control circuitry 122 of FIG. 1 considers (a) local variables with respect to properties of tasks to be performed and current or expected availability of one or more types of autonomous robots to perform the tasks and (b) global variables with respect to conditions in the warehouse 102 that can affect travel of the autonomous robots and performance of the tasks. As disclosed herein, the workload control circuitry 122 executes machine learning models to assign tasks to the autonomous vehicles 116, 118, 120 to facilitate (e.g., optimize, maximize) navigational efficiency of the autonomous vehicles 116, 118, 120 and, thus, efficiency in execution of the tasks.

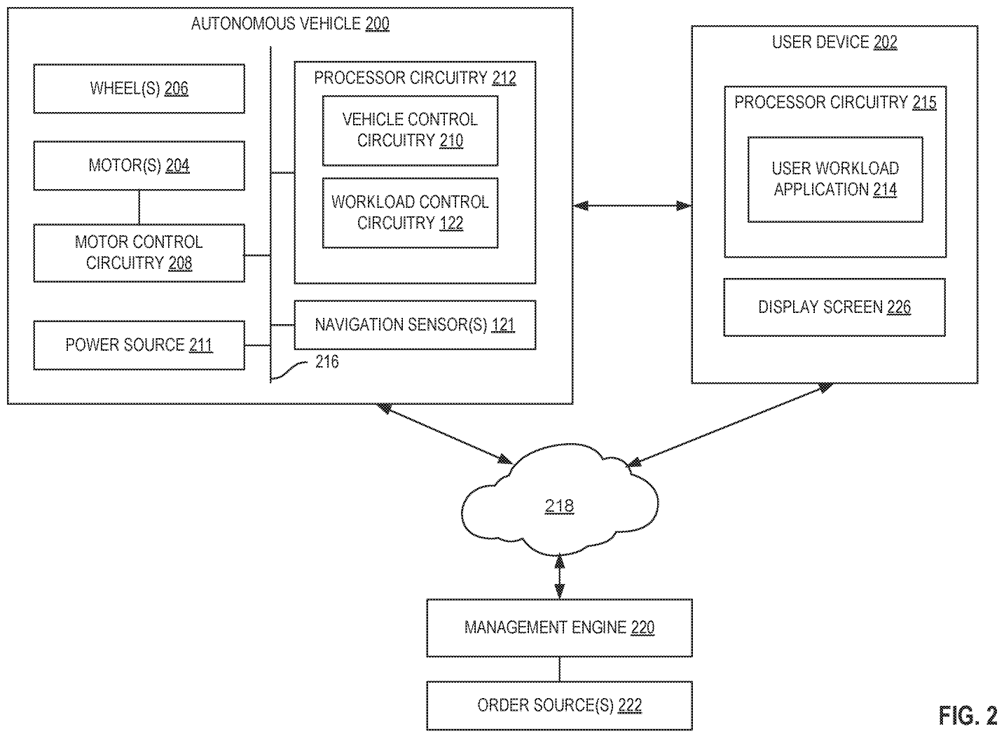

FIG. 2 illustrates an example autonomous vehicle 200, which may be the first autonomous vehicle 116, the second autonomous vehicle 118, or one of the other autonomous vehicles 120 of FIG. 1. FIG. 2 also illustrates an example user device 202 (e.g., the user device 132 of FIG. 1) for use by a user (e.g., the user 130) in the warehouse 102.

The example autonomous robot 200 of FIG. 2 moves to a location in the warehouse 102 without or with limited user input control during movement of the vehicle 200. The example autonomous vehicle 200 of FIG. 2 includes one or more motors 204 (e.g., electric motor(s) and/or other drive mechanism(s)) to cause movement of the autonomous vehicle 200 via wheel(s) 206 of the vehicle 200. The autonomous vehicle 200 includes motor control circuitry 208 (e.g., hardware and/or software components) to control, for example, a speed of the vehicle 200. The autonomous vehicle 200 includes vehicle control circuitry 210 to control movement of the autonomous vehicle 200. In the example of FIG. 2, the vehicle control circuitry 210 is implemented by processor circuitry 212 of the vehicle 200. The example vehicle 200 of FIG. 2 includes a power source 211 such as a battery to provide power to the components of the vehicle 200 communicatively coupled via a bus 216.

The example vehicle 200 includes the sensors 121 (motion sensor(s) (e.g., accelerometer(s)), GPS receiver(s), image sensor(s), etc.) to output signals indicative of a location of the autonomous vehicle 200 in the warehouse 102. The signals from the navigation sensors 121 can be analyzed by the vehicle control circuitry 210 with respect to controlling movement of the vehicle 200.

In the example of FIG. 2, the workload control circuitry 122 is implemented by executable instructions executed on the processor circuitry 212 of the autonomous vehicle 200. However, in other examples, the workload control circuitry 122 is implemented by processor circuitry 215 of the user device 202 in communication with the autonomous vehicle 200 (e.g., via wired or wireless communication protocols), and/or by a cloud-based device 218 (e.g., one or more server(s), processor(s), and/or virtual machine(s)). In other examples, one or more components of the workload control circuitry 122 is implemented by dedicated circuitry located on the autonomous vehicle 200 and/or the user device 202. These components may be implemented in software, hardware, or in any combination of two or more of software, firmware, and/or hardware.

In the example of FIG. 2, the workload control circuitry 122 is in communication with a management engine 220. The management engine 220 receives orders placed by consumers via one or more order source(s) 222. The order source(s) 222 can include, for example, an online store, a phone order, an order placed with a customer service representative, and/or other sources for collecting or obtaining orders. The workload control circuitry 122 receives information related to an order placed via the order source(s) 222 (e.g., an online store) such as the respective products in the order, a priority level assigned to the order (e.g., an urgent order), an expected fulfillment time or shipment date, etc. As disclosed herein, the workload control circuitry 122 assigns task(s) or workload(s) to the autonomous vehicle 200 based on orders received.

The vehicle control circuitry 210 of the autonomous vehicle 200 can cause the autonomous vehicle 200 to move to particular locations in the warehouse 102 of FIG. 1 based on the instructions from the workload control circuitry 122. The vehicle control circuitry 210 can communicate with the workload control circuitry 122 to inform the workload control circuitry when the vehicle 200 has arrived at a location associated with a task (e.g., the inventory storage locations 104, 106, 108, 110, 112), when the vehicle 200 is leaving the location, whether the task was completed or includes an exception, whether the vehicle 200 is available to perform a new task, etc. More generally, the vehicle control circuitry 210 can communicate robot status information to the workload control circuitry 122.

In the example of FIG. 2, a user workload application 224 is executed by the processor circuitry 215 of the user device 202. In some examples, the user workload application 224 can receive instructions from the workload control circuitry 122 with respect to, for instance, task(s) or workload(s) assigned to the particular user (e.g., the user 130) with which the user device 202 is associated. The task(s) and/or workload(s) can be displayed via a display screen 226 of the user device 202. A user can provide inputs via the user workload application 224, such as whether a task has been completed, whether a task is unable to be completed, etc. The user task(s) or workload(s) can be associated with, for instance, a particular order.

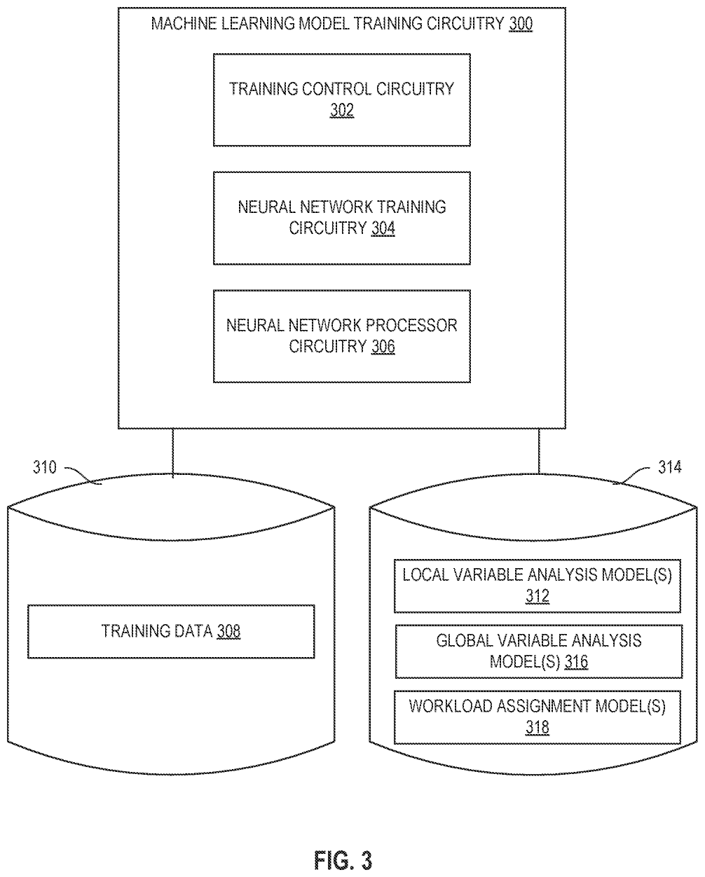

FIG. 3 is a block diagram of machine learning model training circuitry 300 to train machine learning model(s) that are to be executed by the workload control circuitry 122 to assign tasks to autonomous robots (e.g., the autonomous vehicles 116, 118, 120, 200) to improve performance efficiency of the robots (e.g., minimize navigational disruptions to the robots). The machine learning model training circuitry 300 of FIG. 3 may be instantiated (e.g., creating an instance of, bring into being for any length of time, materialize, implement, etc.) by processor circuitry such as a central processing unit executing instructions. Additionally or alternatively, the machine learning model training circuitry 300 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

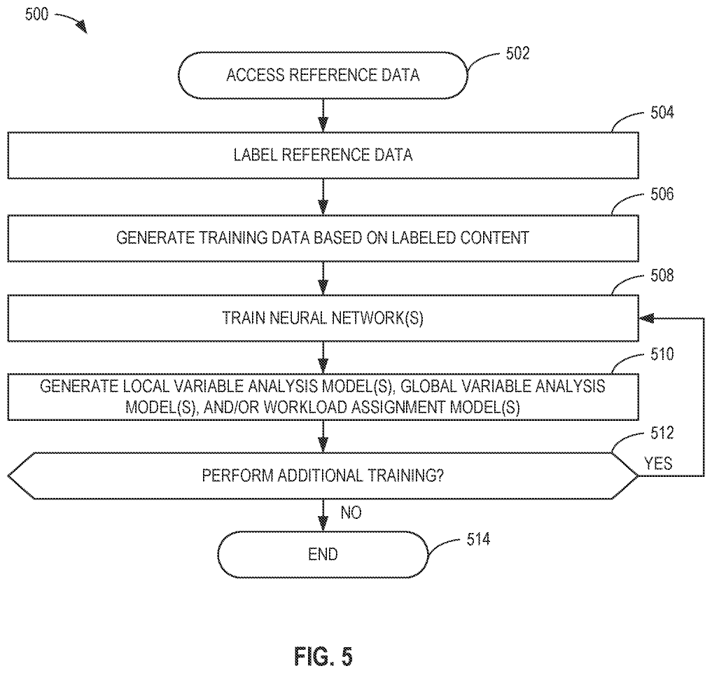

The example machine learning model training circuitry 300 of FIG. 3 includes training control circuitry 302, neural network training circuitry 304, and neural network processor circuitry 306. In some examples, the training control circuitry 302 is instantiated by processor circuitry executing training control instructions and/or configured to perform operations such as those represented by the flowchart of FIG. 5. In some examples, the neural network training circuitry 304 is instantiated by processor circuitry executing training control instructions and/or configured to perform operations such as those represented by the flowchart of FIG. 5.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, training is performed either remotely (e.g., in a cloud or at a server) or locally (e.g., at the robot 116, 118, 120, 200). Training is performed using hyperparameters that control how the learning is performed (e.g., a learning rate, a number of layers to be used in the machine learning model, etc.). Training is performed using training data. In examples disclosed herein, the training data originates from, for instance, the autonomous or automated robots (e.g., the autonomous vehicles 116, 118, 120, 200); other types of equipment (e.g., manually operated equipment 126, 128); user devices (e.g., the user devices 132, 202); sensors carried by the robots(s), equipment, or user devices; sensor(s) located in the environment (e.g., the environment 102, other environments), etc. When supervised training is used, the training data is labeled. In some examples, the training data is pre-processed. In some examples re-training may be performed. Such re-training may be performed in response to, for example, data collected by the autonomous robot(s) 116, 118, 120, 200 while traveling and/or performing tasks.

Once training is complete, the model is deployed for use as an executable construct that processes an input and provides an output based on the network of nodes and connections defined in the model. The model is stored locally in memory (e.g., temporarily stored in a cache and moved into (e.g., main) memory after training) or may be stored in the cloud. The model may then be executed by the workload control circuitry 122.

Once trained, the deployed model may be operated in an inference phase to process data. In the inference phase, data to be analyzed (e.g., live data) is input to the model, and the model executes to create an output. This inference phase can be thought of as executing the model to apply the learned patterns and/or associations to the live data. In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

In examples disclosed herein, the neural network processor circuitry 306 of FIG. 3 implements one or more neural networks. The example neural network training circuitry 304 of FIG. 3 performs training of the neural network(s) implemented by the neural network processor circuitry 306. In some examples disclosed herein, training is performed using a stochastic gradient descent algorithm. However, other approaches to training a neural network(s) may additionally or alternatively be used.

The example training control circuitry 302 of FIG. 3 instructs the neural network training circuitry 304 to perform training of the neural network(s) using training data 308. In the example of FIG. 3, the training data 308 is used by the neural network training circuitry 304 to train the neural network(s) is stored in a database 310.

In the example of FIG. 3, the training data 308 can include data associated with workloads to be performed by autonomous robots, properties of autonomous robots, properties of environments in which the autonomous robots can operate, properties of other equipment and/or workers in the environments, and/or other types of reference data. For example, the training data 308 can include properties of orders (e.g., fulfillment deadlines, service level agreements) and/or goods in the orders (e.g., item location, weight, size, etc.).

The training data 308 can include properties of autonomous robots, such as robot type, capacity, schedules and availability, travel paths, position data, performance metrics (e.g., speed), ability to perform particular tasks, etc. The training data 308 can include images of different types of robots (e.g., robots having arms, robots having forklifts, robots without arms, etc.). The training data 308 can include images of different types of robots performing different tasks.

The training data 308 can include properties of equipment different from the autonomous robots, such as manually operated equipment (e.g., push carts, forklifts). The training data 308 can include data indicative of capacity, availability, travel paths, performance metrics, ability to perform different tasks, etc. in connection with the manually operated equipment. The training data 308 can include images of the manually operated equipment in connection with performance of different tasks. The training data 308 can include data associated with performance of tasks by individual workers, such as performance metrics (e.g., number of tasks performed, speed at which the tasks were performed, historical labor forecasts).

The training data 308 can include data indicative of properties of a warehouse (e.g., the warehouse 102, another warehouse). For example, the training data 308 can include data such as aisle width, shelf height, etc. in different warehouses. The data can include image data labeled with measurements indicative of various aisle widths, shelf heights, etc.

The training data 308 can include other types of reference data such as data indicative of previous instances of minimal levels and/or maximum levels of congestion in the warehouse. In such examples, the training data 308 can include associated job performance metrics by autonomous robots during the different levels of congestion.

The neural network training circuitry 304 trains the neural network(s) implemented by the neural network processor circuitry 306 using the training data 308. For instance, the neural network training circuitry 304 trains the neural network(s) to identify autonomous robots that can perform a particular task in view of properties of the task as well as current or expected availability of resources. The training data 308 including properties of different autonomous robots, the tasks (e.g., goods, fulfillment deadline), and performance metrics of the robots in performing tasks can be used in training the neural network model to select autonomous robots (e.g., eligible autonomous robots) to perform tasks. One or more local variable analysis models 312 are generated as a result of the neural network training. The local variable analysis model(s) 312 are stored in a database 314. The databases 310, 314 may be the same storage device or different storage devices.

In the example of FIG. 3, the neural network training circuitry 304 trains the neural network(s) to consider conditions or variables in the environment at, for instance, a current time or a future time in which a task is to be performed. The training data 308 including properties of the environment, properties of other types or equipment or workers in the environment, properties of tasks, historical data indicative of congestion levels in the workhouse, etc. can be used to train the neural network to account for global conditions in the environment that can affect performance of tasks by autonomous robots. One or more global variable analysis models 316 are generated as a result of the neural network training. The global variable analysis model(s) 316 are stored in the database 314.

In the example of FIG. 3, the neural network training circuitry 304 trains the neural network(s) to assign jobs to autonomous robots at a current time and/or a future time to facilitate (e.g., optimize, maximize) performance efficiency. For example, the neural network training circuitry 304 trains the neural network(s) to assign tasks to minimize disruptions to travel of the autonomous robots in the environment by avoiding congestion between robots, other equipment, and individuals throughout the warehouse while optimizing job performance efficiency. The training data 308, the eligible autonomous robots identified as a result of execution of the local variable analysis model(s) 312, and the environmental conditions identified as a result of execution of the global variable analysis model(s) can be used to train the neural network to consider both local variables (e.g., task type, robot type) and global variables (e.g., congestion in the warehouse) when assigning tasks or workloads to autonomous robots. One or more workload assignment models 318 are generated as a result of the neural network training. The workload assignment model(s) 318 are stored in the database 314.

While an example manner of implementing the machine learning model training circuitry 300 is illustrated in FIG. 3, one or more of the elements, processes, and/or devices illustrated in FIG. 3 may be combined, divided, re-arranged, omitted, eliminated, and/or implemented in any other way. Further, the example training control circuitry 302, the example neural network training circuitry 304, the example neural network processor circuitry 306, and/or, more generally, the example machine learning model training circuitry 300, may be implemented by hardware alone or by hardware in combination with software and/or firmware. Thus, for example, any of the example training control circuitry 302, the example neural network training circuitry 304, the example neural network processor circuitry 306, and/or, more generally, the example machine learning model training circuitry 300, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example machine learning model training circuitry 300 may include one or more elements, processes, and/or devices in addition to, or instead of, those illustrated in FIG. 3, and/or may include more than one of any or all of the illustrated elements, processes, and devices.

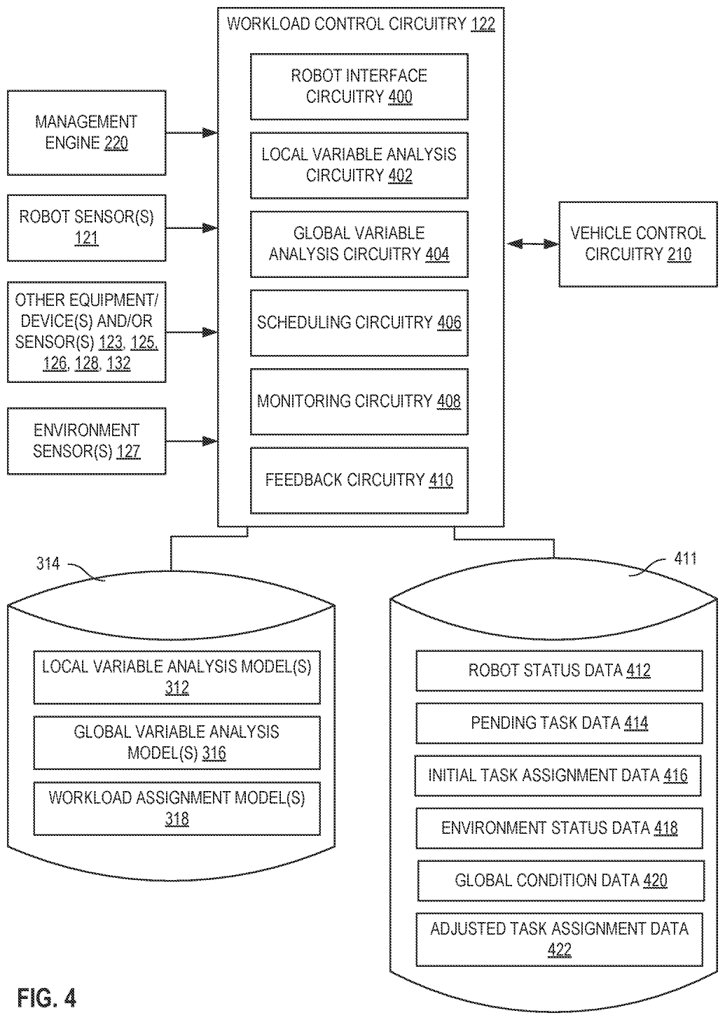

FIG. 4 is a block diagram of the example workload control circuitry 122 of FIGS. 1 and 2 to execute machine learning model(s) to selectively assign tasks to autonomous robots (e.g., the autonomous vehicles 116, 118, 120) in view of task properties, robot properties, and conditions in an environment (e.g., the warehouse 102) such as congestion, availability of other robots and/or equipment to perform the task(s), etc. Based on the execution of the machine learning model(s), the workload control circuitry 122 assigns a particular task to be performed by a robot that prioritizes factors such as efficiency in performing the task relative to other pending or uncompleted tasks. The workload control circuitry 122 of FIG. 4 may be instantiated (e.g., creating an instance of, bring into being for any length of time, materialize, implement, etc.) by processor circuitry such as a central processing unit executing instructions. Additionally or alternatively, the workload control circuitry 122 of FIG. 4 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 4 may, thus, be instantiated at the same or different times. Some or all of the circuitry may be instantiated, for example, in one or more threads executing concurrently on hardware and/or in series on hardware. Moreover, in some examples, some or all of the circuitry of FIG. 4 may be implemented by microprocessor circuitry executing instructions to implement one or more virtual machines and/or containers.

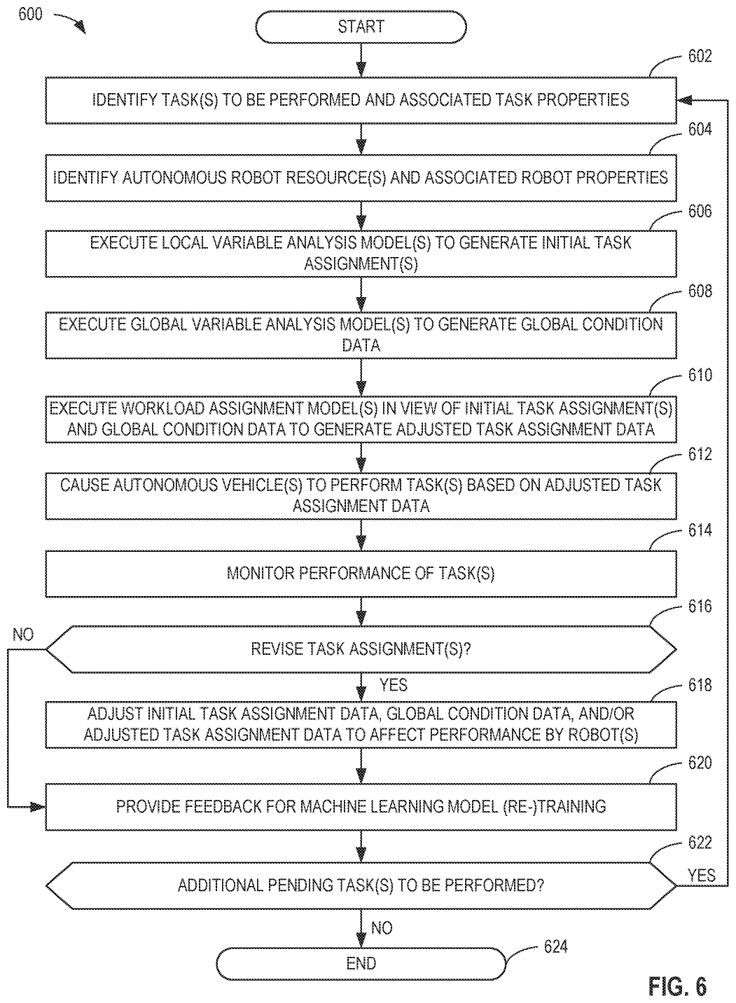

The example workload control circuitry 122 of FIG. 4 includes robot interface circuitry 400, local variable analysis circuitry 402, global variable analysis circuitry 404, scheduling circuitry 406, monitoring circuitry 408, and feedback circuitry 410. In some examples, the robot interface circuitry 400 is instantiated by processor circuitry executing robot interface instructions and/or configured to perform operations such as those represented by the flowchart of FIG. 6. In some examples, the local variable analysis circuitry 402 is instantiated by processor circuitry executing local variable analysis instructions and/or configured to perform operations such as those represented by the flowchart of FIG. 6. In some examples, the global variable analysis circuitry 404 is instantiated by processor circuitry executing global variable analysis instructions and/or configured to perform operations such as those represented by the flowchart of FIG. 6. In some examples, the scheduling circuitry 406 is instantiated by processor circuitry executing scheduling instructions and/or configured to perform operations such as those represented by the flowchart of FIG. 6. In some examples, the monitoring circuitry 408 is instantiated by processor circuitry executing monitoring instructions and/or configured to perform operations such as those represented by the flowchart of FIG. 6. In some examples, the feedback circuitry 410 is instantiated by processor circuitry executing feedback instructions and/or configured to perform operations such as those represented by the flowchart of FIG. 6.

The robot interface circuitry 400 of the example workload control circuitry 122 facilitates communication with the vehicle control circuitry 210 of the autonomous vehicle(s) 116, 118, 120, 200 of FIGS. 1 and 2 (e.g., via wired or wireless communication protocol(s)). For example, the robot interface circuitry 400 can receive data from the vehicle control circuitry 210 of each autonomous vehicle 116, 118, 120, 200 that is indicative of a current location of the autonomous vehicle(s) 116, 118, 120, 200 in the warehouse 102, whether the autonomous vehicle 116, 118, 120, 200 is currently performing a task, whether the autonomous vehicle 116, 118, 120, 200 is currently available to perform a new task, when the autonomous vehicle 116, 118, 120, 200 is expected to be available to perform a new task, etc. In some examples, the robot interface circuitry 400 receives the robot status data 412 directly from the sensor(s) 121 of the respective vehicles 116, 118, 120, 200 (e.g., position data).

The data from the respective autonomous vehicles 116, 118, 120, 200 can be stored as robot status data 412 in a database 411. In some examples, the workload control circuitry 122 includes the database 411. In some examples, the database 411 is located external to the workload control circuitry 122 in a location accessible to the workload control circuitry 122 as shown in FIG. 4.

Also, the robot interface circuitry 400 of FIG. 4 transmits instructions to the vehicle control circuitry 210 of the respective vehicles 116, 118, 120, 200. For example, the robot interface circuitry 400 transmits instructions to cause the vehicles 116, 118, 120, 200 to, for example, move to a particular location in the warehouse 102 in response to assignment of a task.

The local variable analysis circuitry 402 accesses data from the management engine 220 indicating that, for instance, order(s) have been placed for good(s) stored in the warehouse 102 of FIG. 1. The order(s) can be placed by consumers via, for instance, the order source(s) 222 of FIG. 2. The local variable analysis circuitry 402 extracts or identifies pending or uncompleted tasks to be performed based on the data from the management engine 220.

The local variable analysis circuitry 402 identifies properties of the task(s) to be performed in connection with, for instance, fulfillment of an order. For example, the local variable analysis circuitry 402 identifies properties of goods of the order, such as weight, size, location in the warehouse 102, etc. The local variable analysis circuitry 402 identifies completion deadlines associated with the order, the age of the task(s), the priority of the task(s), etc. The local variable analysis circuitry 402 generates pending task data 414 identifying the pending tasks and the corresponding task properties. The pending task data 414 can be stored in the database 411. The local variable analysis circuitry 402 can update the pending task data 414 in response to, for instance, new orders received from the management engine 220.

The local variable analysis circuitry 402 executes the local variable analysis model(s) 312 to identify one or more autonomous vehicles 116, 118, 120, 200 that are available or expected to be available within a threshold period of time to perform one or more of the pending tasks. For example, the local variable analysis circuitry 402 executes the local variable analysis model(s) 312 to identify eligible ones of the autonomous vehicle 116, 118, 120, 200 to perform the pending task(s) based on (a) the robot status data 412, which can identify properties of the robot(s) such as current and future availability of the robot(s), robot type, and capacity, and (b) the pending task data 414 including properties of the tasks to be performed. The eligible autonomous vehicle 116, 118, 120, 200 and corresponding task(s) can be stored as initial task assignment data 416 in the database 411. The local variable analysis circuitry 402 can access the local variable analysis model(s) 312 from the database 314. The databases 314, 411 may be the same storage device or different storage devices.

The global variable analysis circuitry 404 accesses outputs of the sensor(s) 121 carried by the autonomous vehicle(s) 116, 118, 120, 200; the sensor(s) 123 carried by the other equipment in the warehouse 102 (e.g., manually operated equipment); the sensor(s) 125 carried by the user device(s) 130; and/or the environment sensor(s) 127. For example, the global variable analysis circuitry 404 accesses data indicative of locations of the autonomous vehicle(s) 116, 118, 120, 200; the user(s) 130; and/or the equipment 126, 128 in the warehouse. The global variable analysis circuitry 404 can access data indicative of tasks previously assigned to the autonomous vehicle(s) 116, 118, 120, 200; the user(s) 130; and/or the equipment 126, 128 but not yet completed (e.g., in-progress tasks). Data associated with the outputs of the autonomous vehicle(s) 116, 118, 120, 200; the user device(s) 132; the equipment 126, 128; and/or the sensor(s) 121, 123, 125, 127 can be stored in the database 411 as environment status data 418.

The global variable analysis circuitry 404 executes the global variable analysis model(s) 316 to identify (e.g., determine, predict) current and/or expected conditions at the warehouse 102 with respect to, for example, locations of the autonomous vehicles 116, 118, 120, 200 in warehouse 102 and locations of other types of equipment 126, 128 and/or individual(s) 130 in the warehouse 102. In some examples, the global variable analysis circuitry 404 considers properties of tasks currently being performed or expected to be performed within a threshold time period to identify current or expected conditions in the warehouse 102, such as congestion. For example, the global variable analysis circuitry 404 can consider such as location(s) of good(s) associated with the task(s) being performed or expected to be performed in the warehouse 102 at a given time, anticipated fulfillment time, and manner of fulfillment (e.g., by the vehicle(s) 118, 116, 120, 200, by an individual 130, using the equipment 126, 128) to estimate a likelihood of congestion.

As a result of execution of the global variable analysis model(s) 316, the global variable analysis circuitry 404 determines or predicts a likelihood of the presence of conditions in the warehouse that can affect (e.g., negatively impact) performance efficiency of the vehicle(s) 116, 118, 120, 200 in performing the pending tasks. For example, the global variable analysis circuitry 404 can predict instances of congestion at particular area(s) of the warehouse 102 at particular times in view of the environment status data 418. The results of the execution of the global variable analysis model(s) 316 can be stored as global condition data 420. The global variable analysis circuitry 404 can update the global condition data 420 (e.g., the prediction(s)) in response to updated information received from the autonomous vehicle(s) 116, 118, 120, 200; the user device(s) 132; the equipment 126, 128; and/or the sensor(s) 121, 123, 125, 127.

The example scheduling circuitry 406 of FIG. 4 uses the initial task assignment data 416 and the global condition data 420 to assign a pending task to a particular autonomous vehicle 116, 118, 120, 200 that is available or expected to be available to perform tasks. The scheduling circuitry 406 executes the workload assignment model(s) 318 to select a pending task to be performed by a particular autonomous vehicle 116, 118, 120, 200 to minimize disruptions (e.g., navigational disruptions) to the vehicle 116, 118, 120, 200 during performance of the task in view of current or expected conditions at the warehouse 102. In particular, as a result of execution of the workload assignment model(s) 318, the scheduling circuitry 406 assigns a task to an autonomous vehicle 116, 118, 120, 200 such that the task will be completed by the autonomous vehicle 116, 118, 120, 200 to optimize (e.g., increase, maximize, minimize negative effects on) the performance efficiency metrics associated with completion of the task. The performance efficiency metrics can include, for instance, a duration of time for completion of the task, the amount of congestion in the warehouse 102 experienced by the autonomous vehicle 116, 118, 120, 200 when performing the task, the number of disruptions (e.g., unplanned stops) during travel of the autonomous vehicle 116, 118, 120, 200 while completing the task, a success rate in meeting shipping deadlines for an order associated with the task, and/or other conditions that can affect efficiency of the autonomous vehicle 116, 118, 120, 200 in performing the task. The task assignments resulting from execution of the workload assignment model(s) 318 can be saved in the database 411 as adjusted task assignment data 422.

For instance, the initial task assignment data 416 can indicate that the first autonomous vehicle 116 of FIG. 1 is a candidate to perform a first uncompleted task and a second uncompleted task, where the first uncompleted task is assigned a higher priority than the second uncompleted task (e.g., as indicated by the pending task data 414). The scheduling circuitry 406 executes the workload assignment model(s) 318 to select between assigning the first uncompleted task and a second uncompleted task to the first autonomous vehicle 116. The scheduling circuitry 406 can assign the second uncompleted pending task to the first autonomous vehicle 116 if, as a result of execution of the workload assignment model(s) 318, the scheduling circuitry 406 determines that the first autonomous vehicle 116 will be able to complete the second pending task with less navigation disruptions than the first pending task. For example, congestion in the warehouse associated with the location of the first uncompleted task (as indicated by the global condition data 420) can weigh against assigning the first uncompleted task to the first autonomous vehicle 116 because of the likelihood that the first autonomous vehicle 116 will encounter disruptions (e.g., reduced speeds, unplanned stops, increased duration to complete the task) when traveling to or at the location of the first task. Put another way, as result of execution of the workload assignment model(s) 318, the scheduling circuitry 406 selects the second pending task for the first autonomous vehicle 116 because the first autonomous vehicle 116 will achieve better performance condition(s) (e.g., task completion efficiency) for the second pending task than if the first autonomous vehicle 116 was assigned the first pending task.

Instead, the scheduling circuitry 406 can execute the workload assignment model(s) 318 to assign the second autonomous vehicle 118 to perform the first uncompleted task at a later time. For instance, the initial task assignment data 416 can indicate that the second autonomous vehicle 118 is also a candidate to perform the first uncompleted task. Also, the global condition data 420 can indicate that congestion at the location of the first task in the warehouse 102 is expected to alleviate over time. Because the congestion will be alleviated when the second autonomous vehicle 118 performs the first pending task, the second autonomous vehicle will achieve better performance condition(s) for the first task than if the first autonomous vehicle 116 was assigned the first task and encountered the congestion.

In some examples, the scheduling circuitry 406 can assign a third pending task to a third autonomous vehicle 120, where the third pending task is associated with a same location in the warehouse 102 as the second task assigned to the first autonomous vehicle 116. For instance, the scheduling circuitry 406 can assign the third task to the third autonomous vehicle 120 if performance of the third task will not interfere with performance of the second task by the first autonomous vehicle 116 at the location. For example, the scheduling circuitry 406 can cause the third autonomous vehicle 120 to travel to the first location such that the arrival times of the first and third autonomous vehicles 116, 120 at the location is staggered (e.g., to prevent congestion).

In some examples, the scheduling circuitry 406 considers differences in robot type when assigning the first or second uncompleted tasks to the first or second autonomous vehicles 116, 118. In some examples, suitability of a robot type for a particular task can outweigh other factors such as congestion when assigning tasks. For instance, continuing to refer to the above example involving the first and second uncompleted tasks, the first uncompleted task may involve retrieving a good stored on a shelf. The first autonomous vehicle 116 includes a robotic arm, however, the second autonomous vehicle 118 does not include an arm. In this example, the scheduling circuitry 406 can assign the first pending task to the first autonomous vehicle 118 if the scheduling circuitry 406 determines that the first autonomous vehicle 116 can complete the first task more efficiently due to vehicle type (e.g., the robotic arm) as compared to the second autonomous vehicle. Thus, even if the performance of the first task may be impacted by the congestion at the location of the first task, the scheduling circuitry 406 determines that the efficiency of execution of the first task by the first autonomous vehicle 116 outweighs disruptions due to congestion.

In some examples, to minimize disruption to the autonomous vehicles 116, 118, 120, 200 in performing pending tasks, the scheduling circuitry 406 can assign tasks and/or generate schedule(s) of task(s) to be performed by the other equipment 126, 128 (e.g., manually operated equipment) and/or individual(s) 130 to avoid interference with performance of the task(s) assigned to the autonomous vehicle(s) 116, 118, 120, 200. For example, a manually operated forklift may be assigned a first task to retrieve an object for an order but is likely to block or substantially block an aisle in the warehouse 102 while performing the first task. The second autonomous vehicle 118 of FIG. 2 may be assigned a second task that also involves retrieving an item from the same aisle. In this example, the scheduling circuitry 406 can schedule the forklift to perform the first task after the second autonomous vehicle 118 has traveled through the aisle in connection with performance of the second task.

The robot interface circuitry 400 transmits instructions to the vehicle control circuitry 210 of the respective autonomous vehicle(s) 116, 118, 120, 200 that have been assigned tasks based on the adjusted task assignment data 422. The instructions cause the autonomous vehicle(s) 116, 118, 120, 200 to travel and perform the tasks.

In some examples, the adjusted task assignment data 422 can be modified (e.g., overridden) by one or more user inputs. For instance, based on a user input, the adjusted task assignment data 422 can be revised such that an autonomous vehicle 116, 118, 120, 200 is assigned a task based on the age or priority of the task even if the efficiency of the vehicle 116, 118, 120, 200 may be affected.

Although examples disclosed herein are discussed in connection with assigning tasks to autonomous robots, the scheduling circuitry 406 can assign tasks to the other equipment 126, 128 (e.g., manually operated equipment) and/or individual(s) 130 instead of or in addition to autonomous vehicle(s) 116, 118, 120, 200 based on properties of the tasks, availability of the vehicle(s) 116, 118, 120, 200, etc. For instance, the scheduling circuitry 406 can consider variables such as picking speed of individual workers in fulfilling tasks, walking rates for workers, current locations of workers in the warehouse, past efficiency performance metrics for workers, etc. to identify potential users to perform pending tasks having particular properties (e.g., product weight, fulfillment deadline) relative to global conditions in the warehouse 102 (e.g., congestion due to presence of robots and other equipment that can interfere with the workers ability to complete the tasks). Similarly, the scheduling circuitry 406 can consider properties of the other types of equipment 126, 128 such as speed, payload size, accessible heights, navigable aisle width to assign pending tasks to the other equipment 126, 128 in view of the variables such as congestion in the warehouse 102, efficiency of completion of the task using the other equipment as compared to the autonomous vehicles 116, 118, 120, 200, etc. The tasks assigned to the other equipment 126, 128 and/or the individual(s) 130 can be transmitted via the user workload application 214 accessible via the user device 132, 202.

The monitoring circuitry 408 of the example workload control circuitry 122 monitors activity with respect to performance and/or completion of the task(s) assigned to the autonomous vehicle(s) 116, 118, 120, 200 by the scheduling circuitry 406. For example, based on outputs of the vehicle control circuitry 210; the other equipment 126, 128; the user device(s) 132; and/or the sensor(s) 121, 123, 125, 127, the monitoring circuitry 408 can track performance of the task(s) by vehicle(s) 116, 118, 120, 200, identify changes or unexpected in conditions in the warehouse 102 that can affect performance of the tasks, etc. The monitoring circuitry 408 can communicate with the local variable analysis circuitry 402, the global variable analysis circuitry 404, and/or the scheduling circuitry 406 in view of the monitoring. The local variable analysis circuitry 402, the global variable analysis circuitry 404, and/or the scheduling circuitry 406 can modify the evaluation of the tasks, the evaluation of the warehouse conditions, and/or the task assignments based on the monitoring. For example, if the monitoring circuitry 408 determines that a duration of completion of a task by a vehicle 116, 118, 120, 200 is exceeding a threshold due to unexpected congestion in the warehouse 102, the scheduling circuitry 406 determine whether to re-assign the task.

The feedback circuitry 410 of FIG. 4 communicates with the machine learning model training circuitry 300 of FIG. 3 to refine the machine learning model(s) 312, 316, 318 based on performance of the autonomous vehicle(s) 116, 118, 120, 200 with respect to tasks assigned by the scheduling circuitry 406. For instance, the feedback circuitry 410 provides data associated with instances when an autonomous vehicle(s) 116, 118, 120, 200 experienced navigational disruptions due to congestion in the warehouse 102 (e.g., timing data, location data, task properties). The feedback circuitry 410 also provides data associated with instances when an autonomous vehicle(s) 116, 118, 120, 200 did not experience navigational disruptions when performing a task as examples of successful scheduling. The data from the feedback circuitry 410 can be used by the machine learning model training circuitry 300 of FIG. 3 to adjust or refine the model(s) 312, 316, 318.

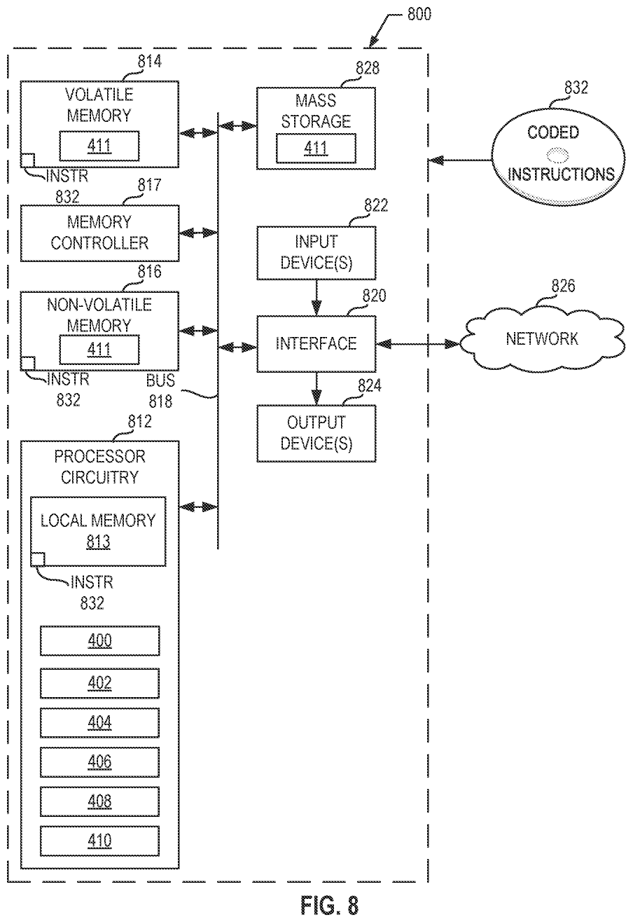

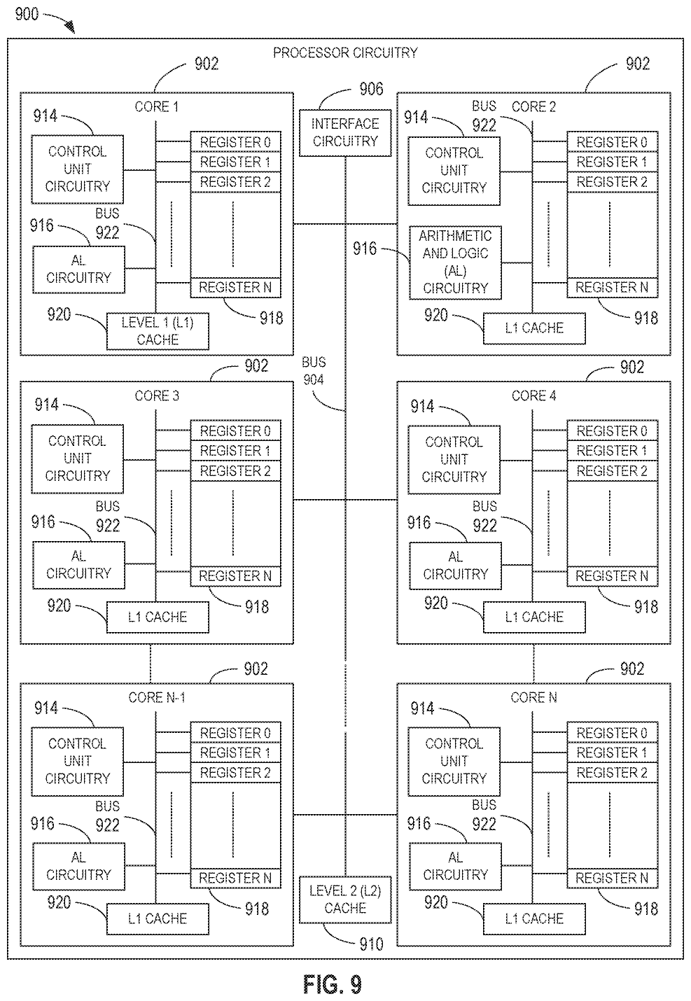

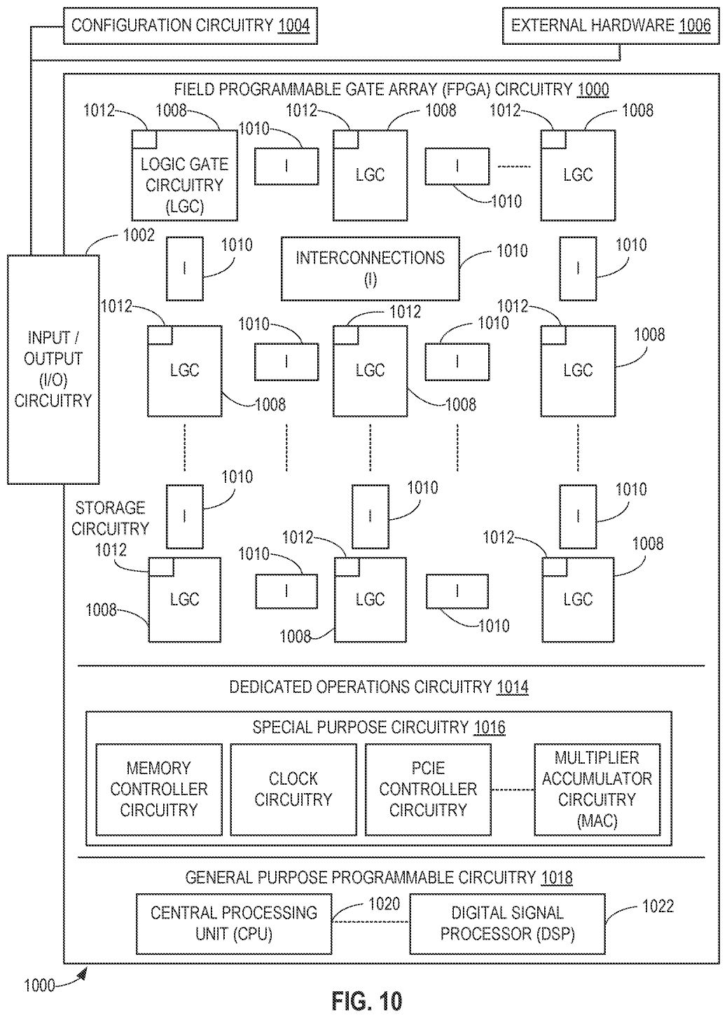

In some examples, the workload control circuitry 122 includes means for interfacing. For example, the means for interfacing may be implemented by the robot interface circuitry 400. In some examples, the robot interface circuitry 400 may be instantiated by processor circuitry such as the example processor circuitry 812 of FIG. 8. For instance, the robot interface circuitry 400 may be instantiated by the example microprocessor 900 of FIG. 9 executing machine executable instructions such as those implemented by at least blocks 612, 618 of FIG. 6. In some examples, the robot interface circuitry 400 may be instantiated by hardware logic circuitry, which may be implemented by an ASIC, XPU, or the FPGA circuitry 1000 of FIG. 10 structured to perform operations corresponding to the machine readable instructions. Additionally or alternatively, the robot interface circuitry 400 may be instantiated by any other combination of hardware, software, and/or firmware. For example, the robot interface circuitry 400 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the workload control circuitry 122 includes means for local variable analyzing. For example, the means for local variable analyzing may be implemented by the local variable analysis circuitry 402. In some examples, the local variable analysis circuitry 402 may be instantiated by processor circuitry such as the example processor circuitry 812 of FIG. 8. For instance, the local variable analysis circuitry 402 may be instantiated by the example microprocessor 900 of FIG. 9 executing machine executable instructions such as those implemented by at least blocks 602, 604, 606, 618 of FIG. 6. In some examples, the local variable analysis circuitry 402 may be instantiated by hardware logic circuitry, which may be implemented by an ASIC, XPU, or the FPGA circuitry 1000 of FIG. 10 structured to perform operations corresponding to the machine readable instructions. Additionally or alternatively, the local variable analysis circuitry 402 may be instantiated by any other combination of hardware, software, and/or firmware. For example, the local variable analysis circuitry 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the workload control circuitry 122 includes means for global variable analyzing. For example, the means for local variable analyzing may be implemented by the global variable analysis circuitry 404. In some examples, the global variable analysis circuitry 404 may be instantiated by processor circuitry such as the example processor circuitry 812 of FIG. 8. For instance, the global variable analysis circuitry 404 may be instantiated by the example microprocessor 900 of FIG. 9 executing machine executable instructions such as those implemented by at least blocks 608, 618 of FIG. 6. In some examples, the global variable analysis circuitry 404 may be instantiated by hardware logic circuitry, which may be implemented by an ASIC, XPU, or the FPGA circuitry 1000 of FIG. 10 structured to perform operations corresponding to the machine readable instructions. Additionally or alternatively, the global variable analysis circuitry 404 may be instantiated by any other combination of hardware, software, and/or firmware. For example, the global variable analysis circuitry 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the workload control circuitry 122 includes means for scheduling. For example, the means for scheduling may be implemented by the scheduling circuitry 406. In some examples, the scheduling circuitry 406 may be instantiated by processor circuitry such as the example processor circuitry 812 of FIG. 8. For instance, the scheduling circuitry 406 may be instantiated by the example microprocessor 900 of FIG. 9 executing machine executable instructions such as those implemented by at least blocks 610, 618 of FIG. 6. In some examples, the scheduling circuitry 406 may be instantiated by hardware logic circuitry, which may be implemented by an ASIC, XPU, or the FPGA circuitry 1000 of FIG. 10 structured to perform operations corresponding to the machine readable instructions. Additionally or alternatively, the scheduling circuitry 406 may be instantiated by any other combination of hardware, software, and/or firmware. For example, the scheduling circuitry 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the workload control circuitry 122 includes means for monitoring. For example, the means for monitoring may be implemented by the monitoring circuitry 408. In some examples, the monitoring circuitry 408 may be instantiated by processor circuitry such as the example processor circuitry 812 of FIG. 8. For instance, the monitoring circuitry 408 may be instantiated by the example microprocessor 900 of FIG. 9 executing machine executable instructions such as those implemented by at least blocks 614, 616 of FIG. 6. In some examples, the monitoring circuitry 408 may be instantiated by hardware logic circuitry, which may be implemented by an ASIC, XPU, or the FPGA circuitry 1000 of FIG. 10 structured to perform operations corresponding to the machine readable instructions. Additionally or alternatively, the monitoring circuitry 408 may be instantiated by any other combination of hardware, software, and/or firmware. For example, the monitoring circuitry 408 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the workload control circuitry 122 includes means for providing feedback. For example, the means for providing feedback may be implemented by the feedback circuitry 410. In some examples, the feedback circuitry 410 may be instantiated by processor circuitry such as the example processor circuitry 812 of FIG. 8. For instance, the feedback circuitry 410 may be instantiated by the example microprocessor 900 of FIG. 9 executing machine executable instructions such as those implemented by at least block 620 of FIG. 6. In some examples, the feedback circuitry 410 may be instantiated by hardware logic circuitry, which may be implemented by an ASIC, XPU, or the FPGA circuitry 1000 of FIG. 10 structured to perform operations corresponding to the machine readable instructions. Additionally or alternatively, the feedback circuitry 410 may be instantiated by any other combination of hardware, software, and/or firmware. For example, the feedback circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the workload control circuitry 122 of FIGS. 1 and/or 2 is illustrated in FIG. 4, one or more of the elements, processes, and/or devices illustrated in FIG. 4 may be combined, divided, re-arranged, omitted, eliminated, and/or implemented in any other way. Further, the example robot interface circuitry 400, the example local variable analysis circuitry 402, the example global variable analysis circuitry 404, the example scheduling circuitry 406, the example monitoring circuitry 408, the example feedback circuitry 410, and/or, more generally, the example workload control circuitry 122 of FIGS. 1 and/or 2, may be implemented by hardware alone or by hardware in combination with software and/or firmware. Thus, for example, any of the example robot interface circuitry 400, the example local variable analysis circuitry 402, the example global variable analysis circuitry 404, the example scheduling circuitry 406, the example monitoring circuitry 408, the example feedback circuitry 410, and/or, more generally, the example workload control circuitry 122, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example workload control circuitry 122 of FIGS. 1 and/or 2 may include one or more elements, processes, and/or devices in addition to, or instead of, those illustrated in FIG. 4, and/or may include more than one of any or all of the illustrated elements, processes and devices.

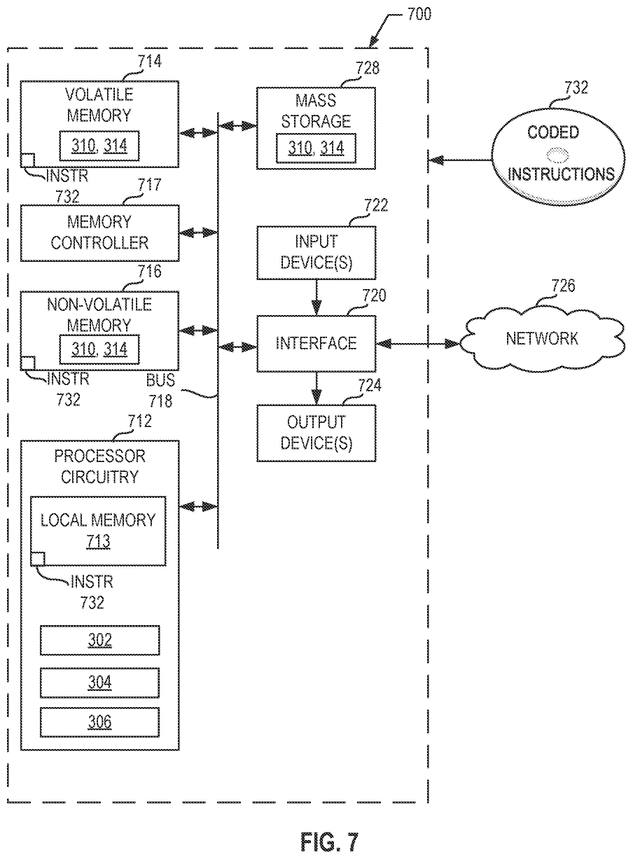

A flowchart representative of example machine readable instructions, which may be executed to configure processor circuitry to implement the machine learning model training circuitry 300 of FIG. 3 is shown in FIG. 5. A flowchart representative of example machine readable instructions, which may be executed to configure processor circuitry to implement the workload control circuitry 122 of FIG. 4 is shown in FIG. 6. The machine readable instructions may be one or more executable programs or portion(s) of an executable program for execution by processor circuitry, such as the processor circuitry 712, 812 shown in the example processor platforms 700, 800 discussed below in connection with FIGS. 7 and 8 and/or the example processor circuitry discussed below in connection with FIGS. 9 and/or 10. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 5 and 6, many other methods of implementing the example machine learning model training circuitry 300 and/or the workload control circuitry 122 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 5 and 6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,”“an,”“first,”“second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to train neural network(s) to assign tasks to autonomous robot(s) (e.g., the autonomous vehicle(s) 116, 118, 120, 200 of FIGS. 1 and 2) to account for performance efficiency of the robot(s) in completing the tasks. The machine readable instructions and/or the operations 500 of FIG. 5 begin at block 502, at which the training control circuitry 302 accesses reference data. The reference data can include, for example, image data, position data, performance metric data generated in connection with performance of tasks by automated or autonomous robots, manually operated equipment, individual(s)) performing tasks, etc. The reference data can include, for example, image data showing different conditions in an environment such as a warehouse including, for instance, varying levels of congestion in the warehouse.

At block 504, the training control circuitry 302 labels the reference data to identify, for instance, levels of high congestion in the warehouse that can negatively affect travel of the autonomous vehicles and levels of low or no congestion that are preferred for travel of the autonomous vehicles. The training control circuitry 302 labels the reference data to identify, for instance, certain robot types that are preferred for performing particular types of tasks over other types of robots. At block 506, the example training control circuitry 302 generates the training data 308 based on the labeled content.

At block 508, the training control circuitry 302 instructs the neural network training circuitry 304 to perform training of the neural network(s) implemented by the neural network processor circuitry 306. As a result of the training, the local variable analysis model(s) 312, the global variable analysis model(s) 316, and the workload assignment model(s) 318 are generated at block 510. The example instructions 500 of FIG. 5 end when no additional training (e.g., re-training) is to be performed (blocks 512, 514).

FIG. 6 is a flowchart representative of example machine readable instructions and/or example operations 600 that may be executed and/or instantiated by processor circuitry selectively assign tasks to autonomous robots (e.g., the autonomous vehicles 116, 118, 120) in view of task properties, robot properties, and conditions in an environment (e.g., the warehouse 102) to optimize (e.g., improve, maximize, minimize disruptions to) performance efficiency for the task. The machine readable instructions and/or the operations 600 of FIG. 6 begin at block 602, at which the local variable analysis circuitry identifies pending task(s) to be performed and properties associated with the task(s) (e.g., the pending task data 414). For example, the local variable analysis circuitry 402 of the example workload control circuitry 122 of FIG. 4 identifies pending or uncompleted task(s) in connection with orders received via the management engine 220. The task properties can include, for instance, good(s) to be retrieved for the order(s), fulfillment deadlines, etc.

At block 604, the local variable analysis circuitry 402 identifies autonomous robots 116, 118, 120, 200 that are available to perform tasks or expected to be available within a threshold period of time based on, for instance, data provided by the vehicle control circuitry 210 of the respective robots 116, 118, 120, 200 (e.g., the robot status data 412). The local variable analysis circuitry 402 identifies properties associated with robots 116, 118, 120, 200 such as robot type.

At block 606, the local variable analysis circuitry 402 executes the local variable analysis model(s) 312 to generate initial task assignment data 416. The local variable analysis circuitry 402 executes the local variable analysis model(s) 312 to identify eligible ones of the autonomous robots 116, 118, 120, 200 to perform the pending task(s) based on the pending task data 414 and the robot status data 412.

At block 608, the global variable analysis circuitry 404 of the example workload control circuitry 122 executes the global variable analysis model(s) 316 to determine or predict a likelihood of the presence of conditions in the environment (e.g., the warehouse 102) that can affect (e.g., negatively impact) performance efficiency of the robot(s) 116, 118, 120, 200 in performing the pending tasks. For example, based on the environment status data 418 (e.g., image data of the environment generated by the sensors 121, 123, 125 associated with the robots, other equipment, and/or user devices) and the global variable analysis model(s) 316, the global variable analysis circuitry 404 can predict instances of congestion at particular area(s) of the warehouse 102 at particular times.

At block 610, the scheduling circuitry 406 of the example workload control circuitry 122 executes the workload assignment model(s) 318 to generate the adjusted task assignment data 422. In particular, the scheduling circuitry 406 executes the workload assignment model(s) in view of the initial task assignment data 416 and the global condition data 420 to select a pending task to be performed by a particular autonomous robot 116, 118, 120, 200 to minimize disruptions (e.g., navigational disruptions) to the robot 116, 118, 120, 200 during performance of the task in view of current or expected conditions at the warehouse 102. Put another away, as a result of execution of the workload assignment model(s) 318, the scheduling circuitry 406 identifies task(s) to be completed by an autonomous robot 116, 118, 120, 200 with to optimize (e.g., improve, increase, maximize, minimize negative effects on) performance efficiency metrics associated with completion of the task. The scheduling circuitry 406 can consider factors such as robot type, warehouse conditions, etc. in assigning task(s) to optimize performance efficiency.

At block 612, the robot interface circuitry 400 of the example workload control circuitry 122 of FIG. 4 transmits instructions to the robot(s) 116, 118, 120, 200 based on the adjusted task assignment data 422 to cause the robot(s) 116, 118, 120, 200 to perform the task(s).

At block 614, the monitoring circuitry 408 of the example workload control circuitry 122 of FIG. 4 monitors performance and/or completion of the task(s) assigned to the autonomous robot(s) 116, 118, 120, 200 by the scheduling circuitry 406. For example, based on outputs of the vehicle control circuitry 210; the other equipment 126, 128; the user device(s) 132; and/or the sensor(s) 121, 123, 125, 127, the monitoring circuitry 408 can track performance of the task(s) by the robot(s) 116, 118, 120, 200, identify changes or unexpected in conditions in the warehouse 102 that can affect performance of the tasks, etc. For instance, the monitoring circuitry 408 can detect that unexpected congestion in the warehouse 102 is causing a duration for completion of a task by a particular robot 116, 118, 120, 200 to increase.

At block 616, the monitoring circuitry 408 determines if the task assignment(s) should be revised in view of the monitoring. At block 618, the local variable analysis circuitry 402, the global variable analysis circuitry 404, and/or the scheduling circuitry 406 can modify the evaluation of the tasks, the evaluation of the warehouse conditions, and/or the task assignments in response to the monitoring to affect (e.g., adjust) the performance of the task(s) by the robot(s) 116, 118, 120, 200 (e.g., via instructions output by the robot control circuitry 400).

At block 620, the feedback circuitry 410 of the example workload control circuitry 122 provides feedback for the machine learning model training circuitry 300. The feedback can be indicative of instances when the autonomous robot(s) 116, 118, 120, 200 experienced navigational disruptions due to congestion in the warehouse 102 (e.g., examples of unsuccessful scheduling), instances in which the robot(s) 116, 118, 120, 200 were not able to efficiency complete a task due to robot type, instances when the robot(s) 116, 118, 120, 200 did not experience navigational disruptions when performing a task (e.g., examples of successful scheduling)

The example instructions 600 of FIG. 6 end when no further pending tasks are identified (blocks 622, 624).

FIG. 7 is a block diagram of an example processor platform 700 structured to execute and/or instantiate the machine readable instructions and/or the operations of FIG. 5 to implement the machine learning model training circuitry 300 of FIG. 3. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs, microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example training control circuitry 302, the example neural network training circuitry 304, and the example neural network processor circuitry 306.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 732, which may be implemented by the machine readable instructions of FIG. 5, may be stored in the mass storage device 728, in the volatile memory 714, in the non-volatile memory 716, and/or on a removable non-transitory computer readable storage medium such as a CD or DVD.

FIG. 8 is a block diagram of an example processor platform 800 structured to execute and/or instantiate the machine readable instructions and/or the operations of FIG. 6 to implement the workload control circuitry 122 of FIG. 4. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 800 of the illustrated example includes processor circuitry 812. The processor circuitry 812 of the illustrated example is hardware. For example, the processor circuitry 812 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 812 implements the example robot interface circuitry 400, the example local variable analysis circuitry 402, the example global variable analysis circuitry 404, the example scheduling circuitry 406, the example monitoring circuitry 408, and the example feedback circuitry 410.

The processor circuitry 812 of the illustrated example includes a local memory 813 (e.g., a cache, registers, etc.). The processor circuitry 812 of the illustrated example is in communication with a main memory including a volatile memory 814 and a non-volatile memory 816 by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817.

The processor platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user to enter data and/or commands into the processor circuitry 812. The input device(s) 822 can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 800 of the illustrated example also includes one or more mass storage devices 828 to store software and/or data. Examples of such mass storage devices 828 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 832, which may be implemented by the machine readable instructions of FIG. 6, may be stored in the mass storage device 828, in the volatile memory 814, in the non-volatile memory 816, and/or on a removable non-transitory computer readable storage medium such as a CD or DVD.

FIG. 9 is a block diagram of an example implementation of the processor circuitry 712 of FIG. 7 and/or the processor circuitry 812 of FIG. 8. In this example, the processor circuitry 712 of FIG. 7 and/or the processor circuitry 812 of FIG. 8 is implemented by a microprocessor 900. For example, the microprocessor 900 may be a general purpose microprocessor (e.g., general purpose microprocessor circuitry). The microprocessor 900 executes some or all of the machine readable instructions of the flowcharts of FIGS. 5 and/or 6 to effectively instantiate the circuitry of FIGS. 3 and/or 4 as logic circuits to perform the operations corresponding to those machine readable instructions. In some such examples, the circuitry of FIGS. 3 and/or 4 is instantiated by the hardware circuits of the microprocessor 900 in combination with the instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 5 and/or 6.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 714, 716 of FIG. 7, the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating point operations. In yet other examples, the AL circuitry 916 may include first AL circuitry that performs integer based operations and second AL circuitry that performs floating point operations. In some examples, the AL circuitry 916 may be referred to as an Arithmetic Logic Unit (ALU). The registers 918 are semiconductor-based structures to store data and/or instructions such as results of one or more of the operations performed by the AL circuitry 916 of the corresponding core 902. For example, the registers 918 may include vector register(s), SIMD register(s), general purpose register(s), flag register(s), segment register(s), machine specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure including distributed throughout the core 902 to shorten access time. The second bus 922 may be implemented by at least one of an I2C bus, a SPI bus, a PCI bus, or a PCIe bus

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 10 is a block diagram of another example implementation of the processor circuitry 712 of FIG. 7 and/or the processor circuitry 812 of FIG. 8. In this example, the processor circuitry 712 and/or the processor circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the machine readable instructions in hardware and, thus, can often execute the operations faster than they could be performed by a general purpose microprocessor executing the corresponding software.

More specifically, in contrast to the microprocessor 900 of FIG. 9 described above (which is a general purpose device that may be programmed to execute some or all of the machine readable instructions represented by the flowcharts of FIGS. 5 and/or 6 but whose interconnections and logic circuitry are fixed once fabricated), the FPGA circuitry 1000 of the example of FIG. 10 includes interconnections and logic circuitry that may be configured and/or interconnected in different ways after fabrication to instantiate, for example, some or all of the machine readable instructions represented by the flowcharts of FIGS. 5 and/or 6. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the software represented by the flowcharts of FIGS. 5 and/or 6. As such, the FPGA circuitry 1000 may be structured to effectively instantiate some or all of the machine readable instructions of the flowcharts of FIGS. 5 and/or 6 as dedicated logic circuits to perform the operations corresponding to those software instructions in a dedicated manner analogous to an ASIC. Therefore, the FPGA circuitry 1000 may perform the operations corresponding to the some or all of the machine readable instructions of FIGS. 5 and/or 6 faster than the general purpose microprocessor can execute the same.

In the example of FIG. 10, the FPGA circuitry 1000 is structured to be programmed (and/or reprogrammed one or more times) by an end user by a hardware description language (HDL) such as Verilog. The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain machine readable instructions to configure the FPGA circuitry 1000, or portion(s) thereof. In some such examples, the configuration circuitry 1004 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1006 may be implemented by external hardware circuitry. For example, the external hardware 1006 may be implemented by the microprocessor 900 of FIG. 9. The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations that may correspond to at least some of the machine readable instructions of FIG. 5 and/or 6 and/or other desired operations. The logic gate circuitry 1008 shown in FIG. 10 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example Dedicated Operations Circuitry 1014. In this example, the Dedicated Operations Circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the processor circuitry 712 of FIG. 7 and/or the processor circuitry 812 of FIG. 8, many other approaches are contemplated. For example, as mentioned above, modern FPGA circuitry may include an on-board CPU, such as one or more of the example CPU 1020 of FIG. 10. Therefore, the processor circuitry 712 of FIG. 7 and/or the processor circuitry 812 of FIG. 8 may additionally be implemented by combining the example microprocessor 900 of FIG. 9 and the example FPGA circuitry 1000 of FIG. 10. In some such hybrid examples, a first portion of the machine readable instructions represented by the flowcharts of FIGS. 5 and/or 6 may be executed by one or more of the cores 902 of FIG. 9, a second portion of the machine readable instructions represented by the flowcharts of FIGS. 5 and/or 6 may be executed by the FPGA circuitry 1000 of FIG. 10, and/or a third portion of the machine readable instructions represented by the flowcharts of FIGS. 5 and/or 6 may be executed by an ASIC. It should be understood that some or all of the circuitry of FIGS. 3 and/or 4 may, thus, be instantiated at the same or different times. Some or all of the circuitry may be instantiated, for example, in one or more threads executing concurrently and/or in series. Moreover, in some examples, some or all of the circuitry of FIGS. 3 and/or 4 may be implemented within one or more virtual machines and/or containers executing on the microprocessor.

In some examples, the processor circuitry 712 of FIG. 7 and/or the processor circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the processor circuitry 712 of FIG. 7 and/or the processor circuitry 812 of FIG. 8, which may be in one or more packages. For example, the XPU may include a CPU in one package, a DSP in another package, a GPU in yet another package, and an FPGA in still yet another package.

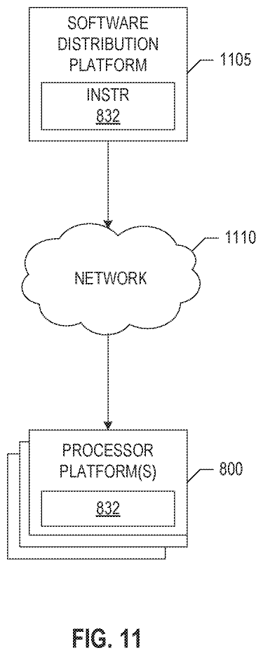

A block diagram illustrating an example software distribution platform 1105 to distribute software such as the example machine readable instructions 832 of FIG. 8 to hardware devices owned and/or operated by third parties is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions 600 of FIG. 6, as described above. The one or more servers of the example software distribution platform 1105 are in communication with an example network 1110, which may correspond to any one or more of the Internet and/or any of the example networks 826 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions 832 of FIG. 8, may be downloaded to the example processor platform 800, which is to execute the machine readable instructions 832 to implement the workload control circuitry 122. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices.

From the foregoing, it will be appreciated that example systems, methods, apparatus, and articles of manufacture have been disclosed that provide for assignment of tasks to autonomous robots to optimize performance efficiency of the robots in completing the tasks. Examples disclosed herein consider local variable such as properties of the tasks to be completed and properties of the autonomous robots to identify eligible robots to complete the tasks. Examples disclosed herein also consider global variables such as conditions in an environment in which the robots are traveling that could affect performance of the tasks, such as congestion in one or more areas of a warehouse. Examples disclosed herein assign tasks to robots to minimize disruptions to travel of the robots and, thus, facilitate efficient completion of the tasks. Examples disclosed herein balance the local variables (e.g., task deadlines) and the global variables (e.g., congestion) to intelligently assign tasks while considering performance efficiency.

Example systems, apparatus, and methods to improve performance efficiency of autonomous robots are disclosed herein. Further examples and combinations thereof include the following:

Example 1 includes an apparatus comprising memory; machine readable instructions; and processor circuitry to execute the machine readable instructions to identify a first task and a second task, the first task associated with a first location and the second task associated with a second location, the second location different than the first location; detect a first condition associated with the first location, the first condition to affect a first task performance condition associated with performance of the first task by an autonomous vehicle, the first condition including congestion at the first location; detect a second condition associated with the second location, the second condition to affect a second task performance condition associated with performance of the second task by the autonomous vehicle; select one of the first task or the second task to be performed by the autonomous vehicle based on the first condition and the second condition; and cause the autonomous vehicle to travel to the first location or the second location to perform the selected one of the first task or the second task.

Example 2 includes the apparatus of example 1, wherein the autonomous vehicle is a first autonomous vehicle, the first autonomous vehicle associated with a first vehicle type and the processor circuitry is to select the one of the first task or the second task to be performed by the first autonomous vehicle based on the first vehicle type relative to a second vehicle type associated with a second autonomous vehicle.

Example 3 includes the apparatus of examples 1 or 2, wherein the second condition includes a location of a product associated with the second task at the second location.

Example 4 includes the apparatus of any of examples 1-3, wherein the autonomous vehicle is a first autonomous vehicle and the processor circuitry is to detect the first condition based on a location of one or more other autonomous vehicles relative to the first location, the one or more other autonomous vehicles different than the first autonomous vehicle.

Example 5 includes the apparatus of any of examples 1-4, wherein the processor circuitry is to detect the first condition based on a location of equipment relative to the first location, the equipment different than the first autonomous vehicle or the one or more other autonomous vehicles.

Example 6 includes the apparatus of any of examples 1-5, wherein the first task performance condition includes one or more of a duration of time for completion of the first task or a number of unplanned stops by the autonomous vehicle during travel to the first location.

Example 7 includes the apparatus of any of examples 1-6, wherein the autonomous vehicle is a first autonomous vehicle, the processor circuitry to select the first task to be performed by the first autonomous vehicle, and the processor circuitry is to identify a second autonomous vehicle to perform a third task, the third task associated with the first location; determine an expected time at which the first autonomous vehicle is to arrive at the first location; identify a time for the second autonomous vehicle to travel to the first location based on the expected time for the first autonomous vehicle; and cause the second autonomous vehicle to travel to the first location to perform the third task at the identified time.

Example 8 includes the apparatus of any of examples 1-7, wherein the processor circuitry is to select the one of the first task or the second task based on respective priority levels assigned to the first task and the second task.

Example 9 includes an apparatus comprising memory; machine-readable instructions; and processor circuitry to execute the machine-readable instructions to identify a first pending task having a first priority level and a second pending task having a second priority level, the first priority level higher than the second priority level, the first pending task associated with a first location in an environment and the second pending task associated with a second location in the environment, the first location different than the second location; identify a first condition and a second condition associated with the environment, the first condition to affect performance of the first pending task by a first autonomous robot and the second condition to affect performance of the second pending task by the first autonomous robot; cause the first autonomous robot to travel to the second location to perform the second pending task at a first time; and cause the first autonomous robot or a second autonomous robot to perform the first pending task at a second time, the second time after the first time.

Example 10 includes the apparatus of example 9, wherein the processor circuitry is to select the first autonomous robot to perform the second pending task at the first time based on the first condition, the second condition, and a property of the first autonomous robot.

Example 11 includes the apparatus of examples 9 or 10, wherein the property of the first autonomous robot includes vehicle type.

Example 12 includes the apparatus of any of examples 9-11, wherein the first condition includes congestion due to a presence of one or more other autonomous robots in a travel path of the first autonomous robot or one or more equipment devices in the travel path, the equipment devices different than the first autonomous robot and the one or more other autonomous robots.

Example 13 includes the apparatus of any of examples 9-12, wherein the processor circuitry is to identify the first condition by predicting a likelihood of congestion in the environment based on the presence of one or more other autonomous robots.

Example 14 includes a non-transitory machine readable storage medium comprising instructions that cause processor circuitry to at least detect a first condition associated with a first location, the first condition to affect performance of a first task by an autonomous robot at the first location; detect a second condition associated with a second location, the second condition to affect performance of a second task by the autonomous robot at the second location, at least one of the first condition or the second condition including congestion at the corresponding first location or the second location; select one of the first task or the second task to be performed by the autonomous robot based on the first condition and the second condition; and cause the autonomous robot to perform the selected one of the first task or the second task.

Example 15 includes the non-transitory machine readable storage medium of example 14, wherein the autonomous robot is a first autonomous robot, the first autonomous robot associated with a first robot type and the instructions cause the processor circuitry to select the one of the first task or the second task to be performed by the first autonomous robot based on the first robot type relative to a second robot type associated with a second autonomous robot.

Example 16 includes the non-transitory machine readable storage medium of examples 14 or 15, wherein the autonomous robot is a first autonomous robot and the instructions cause the processor circuitry to detect the first condition based on a location of one or more other autonomous robots relative to the first location, the one or more other autonomous robots different than the first autonomous robot.

Example 17 includes the non-transitory machine readable storage medium of any of examples 14-16, wherein the instructions cause the processor circuitry is to detect the first condition based on a location of equipment relative to the first location, the equipment to be manually operated.

Example 18 includes the non-transitory machine readable storage medium of any of examples 14-17, wherein the instructions cause the processor circuitry to determine that the first condition will affect one or more of a duration of time for completion of the first task or a number of unplanned stops by the autonomous robot during travel to the first location.

Example 19 includes the non-transitory machine readable storage medium of any of examples 14-18, wherein the autonomous robot is a first autonomous robot, the processor circuitry to select the first task to be performed by the first autonomous robot, and the instructions cause the processor circuitry to identify a second autonomous robot to perform a third task, the third task associated with the first location; determine an expected time at which the first autonomous robot is to arrive at the first location; identify a time for the second autonomous robot to travel to the first location based on the expected time for the first autonomous robot; and cause the second autonomous robot to travel to the first location to perform the third task at the identified time.

Example 20 includes the non-transitory machine readable storage medium of any of examples 14-19, wherein the instructions cause the processor circuitry is to select the one of the first task or the second task based on respective priority levels assigned to the first task and the second task.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
memory;
machine readable instructions; and
processor circuitry to execute the machine readable instructions to:
identify a first task and a second task, the first task associated with a first location and the second task associated with a second location, the second location different than the first location;
detect a first condition associated with the first location, the first condition to affect a first task performance condition associated with performance of the first task by an autonomous vehicle, the first condition including congestion at the first location;
detect a second condition associated with the second location, the second condition to affect a second task performance condition associated with performance of the second task by the autonomous vehicle;
select one of the first task or the second task to be performed by the autonomous vehicle based on the first condition and the second condition; and
cause the autonomous vehicle to travel to the first location or the second location to perform the selected one of the first task or the second task.

2. The apparatus of claim 1, wherein the autonomous vehicle is a first autonomous vehicle, the first autonomous vehicle associated with a first vehicle type and the processor circuitry is to select the one of the first task or the second task to be performed by the first autonomous vehicle based on the first vehicle type relative to a second vehicle type associated with a second autonomous vehicle.

3. The apparatus of claim 1, wherein the second condition includes a location of a product associated with the second task at the second location.

4. The apparatus of claim 3, wherein the autonomous vehicle is a first autonomous vehicle and the processor circuitry is to detect the first condition based on a location of one or more other autonomous vehicles relative to the first location, the one or more other autonomous vehicles different than the first autonomous vehicle.

5. The apparatus of claim 3, wherein the processor circuitry is to detect the first condition based on a location of equipment relative to the first location, the equipment different than the first autonomous vehicle or the one or more other autonomous vehicles.

6. The apparatus of claim 1, wherein the first task performance condition includes one or more of a duration of time for completion of the first task or a number of unplanned stops by the autonomous vehicle during travel to the first location.

7. The apparatus of claim 1, wherein the autonomous vehicle is a first autonomous vehicle, the processor circuitry to select the first task to be performed by the first autonomous vehicle, and the processor circuitry is to:
identify a second autonomous vehicle to perform a third task, the third task associated with the first location;
determine an expected time at which the first autonomous vehicle is to arrive at the first location;
identify a time for the second autonomous vehicle to travel to the first location based on the expected time for the first autonomous vehicle; and
cause the second autonomous vehicle to travel to the first location to perform the third task at the identified time.

8. The apparatus of claim 1, wherein the processor circuitry is to select the one of the first task or the second task based on respective priority levels assigned to the first task and the second task.

9. An apparatus comprising:
memory;
machine-readable instructions; and
processor circuitry to execute the machine-readable instructions to:
identify a first pending task having a first priority level and a second pending task having a second priority level, the first priority level higher than the second priority level, the first pending task associated with a first location in an environment and the second pending task associated with a second location in the environment, the first location different than the second location;
identify a first condition and a second condition associated with the environment, the first condition to affect performance of the first pending task by a first autonomous robot and the second condition to affect performance of the second pending task by the first autonomous robot;
cause the first autonomous robot to travel to the second location to perform the second pending task at a first time; and
cause the first autonomous robot or a second autonomous robot to perform the first pending task at a second time, the second time after the first time.

10. The apparatus of claim 9, wherein the processor circuitry is to select the first autonomous robot to perform the second pending task at the first time based on the first condition, the second condition, and a property of the first autonomous robot.

11. The apparatus of claim 10, wherein the property of the first autonomous robot includes vehicle type.

12. The apparatus of claim 9, wherein the first condition includes congestion due to a presence of one or more other autonomous robots in a travel path of the first autonomous robot or one or more equipment devices in the travel path, the equipment devices different than the first autonomous robot and the one or more other autonomous robots.

13. The apparatus of claim 12, wherein the processor circuitry is to identify the first condition by predicting a likelihood of congestion in the environment based on the presence of one or more other autonomous robots.

14. A non-transitory machine readable storage medium comprising instructions that cause processor circuitry to at least:
detect a first condition associated with a first location, the first condition to affect performance of a first task by an autonomous robot at the first location;
detect a second condition associated with a second location, the second condition to affect performance of a second task by the autonomous robot at the second location, at least one of the first condition or the second condition including congestion at the corresponding first location or the second location;
select one of the first task or the second task to be performed by the autonomous robot based on the first condition and the second condition; and
cause the autonomous robot to perform the selected one of the first task or the second task.

15. The non-transitory machine readable storage medium of claim 14, wherein the autonomous robot is a first autonomous robot, the first autonomous robot associated with a first robot type and the instructions cause the processor circuitry to select the one of the first task or the second task to be performed by the first autonomous robot based on the first robot type relative to a second robot type associated with a second autonomous robot.

16. The non-transitory machine readable storage medium of claim 15, wherein the autonomous robot is a first autonomous robot and the instructions cause the processor circuitry to detect the first condition based on a location of one or more other autonomous robots relative to the first location, the one or more other autonomous robots different than the first autonomous robot.

17. The non-transitory machine readable storage medium of claim 15, wherein the instructions cause the processor circuitry is to detect the first condition based on a location of equipment relative to the first location, the equipment to be manually operated.

18. The non-transitory machine readable storage medium of claim 14, wherein the instructions cause the processor circuitry to determine that the first condition will affect one or more of a duration of time for completion of the first task or a number of unplanned stops by the autonomous robot during travel to the first location.

19. The non-transitory machine readable storage medium of claim 14, wherein the autonomous robot is a first autonomous robot, the processor circuitry to select the first task to be performed by the first autonomous robot, and the instructions cause the processor circuitry to:
identify a second autonomous robot to perform a third task, the third task associated with the first location;
determine an expected time at which the first autonomous robot is to arrive at the first location;
identify a time for the second autonomous robot to travel to the first location based on the expected time for the first autonomous robot; and
cause the second autonomous robot to travel to the first location to perform the third task at the identified time.

20. The non-transitory machine readable storage medium of claim 14, wherein the instructions cause the processor circuitry is to select the one of the first task or the second task based on respective priority levels assigned to the first task and the second task.
